(19) United States
(12) Patent Application Publication
(10) Pub. No.: US 2016/0372997 A1
(43) Pub. Date: Dec. 22, 2016

(54) Linear Vibration Motor

(71) Applicants: Hongxing Wang, Shenzhen (CN); Lubin Mao, Shenzhen (CN)

(72) Inventors: Hongxing Wang, Shenzhen (CN); Lubin Mao, Shenzhen (CN)

(73) Assignee: AAC Technologies Pte. Ltd., Singapore city (SG)

(21) Appl. No.: 15/005,049

(22) Filed: Jan. 25, 2016

(30) Foreign Application Priority Data
Jun. 18, 2015 (CN) 201520425974.4

(51) Int. Cl. H02K 33/00

(52) U.S. Cl. CPC H02K 33/00

(57) ABSTRACT

A vibration motor is disclosed. The vibration motor includes a housing with a receiving space, a vibration part received in the receiving space and an elastic part located between the housing and the vibration part; a guide post located between the housing and the vibration part, and contacting the vibration part through a bearing.

### FIELD OF THE INVENTION

The present disclosure is related to motors, specifically to a linear vibration motor.

### DESCRIPTION OF RELATED ART

A vibration motor is a part of utilizing generation principle of electromagnetic force to transform electric energy into mechanical energy. Generally the vibration motor is installed in the portable telephone to generate silent receipt signal to prevent the inconvenience caused to other people due to external sound. The vibration motor mainly can be divided into rotating vibration motor and linear vibration motor. Among which rotor of weight imbalance rotates under the rotation of vibration motor, so mechanical vibration is generated. In addition, under the linear vibration motor, motor is driven by electromagnetic force linearly, the mechanical vibration is generated. The electromagnetic force has the resonant frequency using spring and vibrator hung in the spring.

China patent with application number 201320780850.9 discloses one kind of linear vibration motor, including a cabinet, a vibration block received in cabinet and a flat leaf spring placed between the cabinet and the vibration block. Magnetic circuit system is set in the vibration block. When linear motor part is at operating state, the vibration unit vibrates linearly and horizontally. Among the actual usage, the vibration unit will deflect upward or downward when it vibrates linearly, it will seriously influence the stability of magnetic circuit system in the position in the housing to cause low reliability of product.

Therefore, it is necessary to provide a new linear vibration motor to overcome the problems mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a linear vibration motor in accordance with an exemplary embodiment of the present disclosure.

FIG. 2 is an isometric and broken view of the linear vibration motor.

FIG. 3 is an isometric and exploded view of linear vibration motor.

FIG. 4 is an isometric view of a linear vibration motor in accordance with a second exemplary embodiment of the present disclosure.

### DETAILED DESCRIPTION OF THE EXEMPLARY EMBODIMENTS

The present invention will hereinafter be described in detail with reference to exemplary embodiments. To make the technical problems to be solved, technical solutions and beneficial effects of present disclosure more apparent, the present disclosure is described in further detail together with the figures and the embodiments. It should be understood the specific embodiments described hereby is only to explain this disclosure, not intended to limit this disclosure.

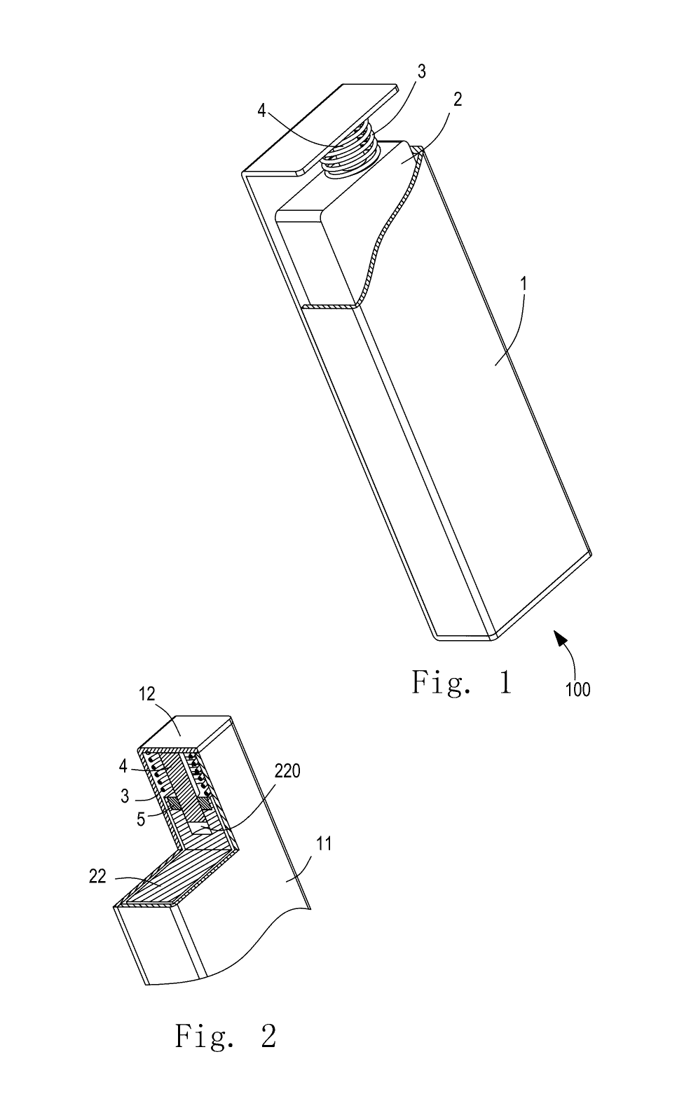

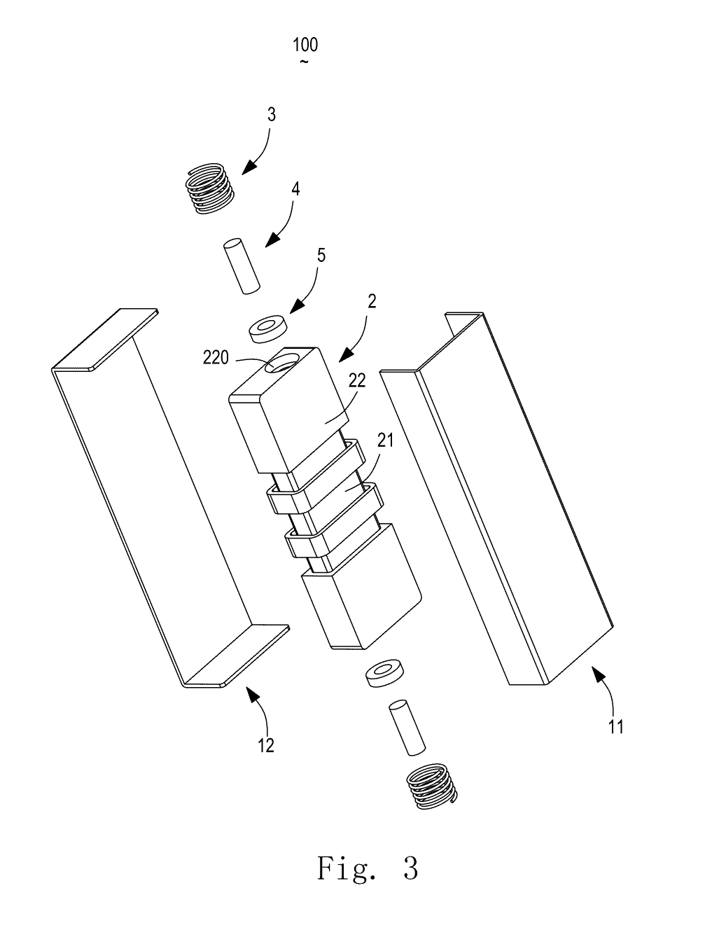

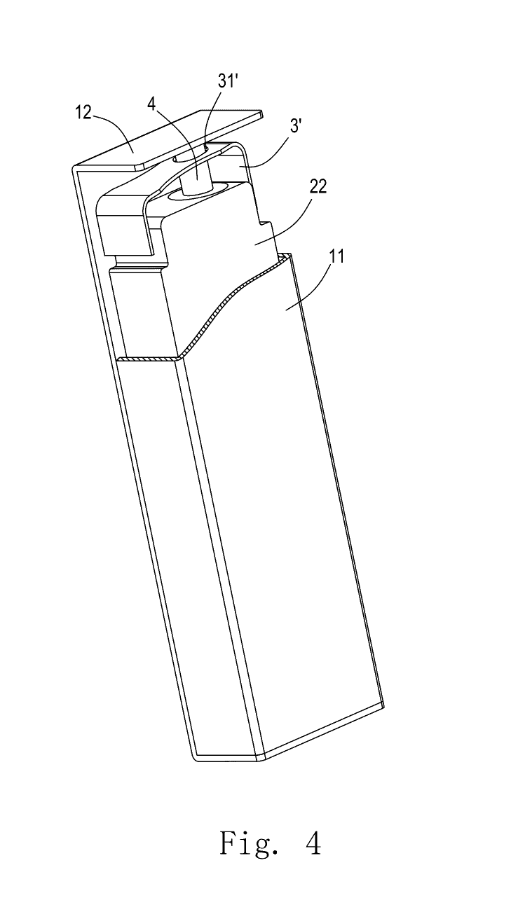

Referring to FIGS. 1-3, a linear vibration motor 100 in accordance with a first embodiment includes a housing 1 having a receiving space 10, a vibration part received in the receiving space 10, an elastic part located between the housing 1 and the vibration part 2, and a guide post 4 located between the said housing 1 and vibration part 2.

The housing 1 includes a support frame 12 for supporting the vibration part 2 and an upper cover 11 forming the receiving space 10 with the support frame 12 to receive the vibration part 2.

Define the vibration part 2 to vibrate linearly along a horizontal direction. The vibration part 2 includes a magnetic circuit mechanism 21 and a mass block 22 located on two ends of magnetic circuit mechanism 21 along the vibration direction. Receiving holes 220 are set on one end of each mass block 22 away from magnetic circuit. Among which, the bearing 5 is installed on the opening of receiving hole 220. A length from the bearing 5 to the bottom of receiving hole 220 is larger than the maximum displacement distance of the moving vibration part 2 to ensure that the bearing 5 is sheathed on the guide post always when vibration part 2 moves.

One end of guide post 4 is fixed or contacts the support frame 12 of the housing 1. The other end of the guide post 14 extends to the receiving hole 220 of the mass block 22 to contact the vibration part 2. Vibration part 2 travels to and fro along the guide post 4. The outside of the above-mentioned bearing 5 is located on the opening of receiving hole 220 and sheathed on the guide post 4 to reduce the friction force between the moving vibration part 2 and the guide post 4.

The elastic part is a spiral spring 3. The spiral spring 3 is sheathed on the guide post 4, with one end abutted on the support frame 12 of the housing 1, and the other end abutted on the mass block 22 of vibration part to provide restoring force to the motion of the vibration part 2. The mean diameter of the spiral spring 3 is larger than that of guide post 4.

The elastic part is set a leaf spring 3′. One end of the flat leaf spring 3′is connected with the block 22. The other end is connected with the housing 1 to provide restoring force of motion of vibration part 2. A through-hole 31′ is set on the flat leaf spring 3′ to go through the said guide post 4. The diameter of through-hole 31′ is larger than that of the guide post 4.

The guide post 4 is set on the linear vibration motor 100 of the above-mentioned two exemplary embodiments to limit the path of vibration part 2 when it moves to ensure the unicity of direction of motion of the vibration part 2. At the same time, the elastic part sheathed on the guide post 4 to ensure unicity of the direction of the elastic force provided by the elastic part to add elastic part to provide the effectiveness of elastic force.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A linear vibration motor, including:
a housing with a receiving space,
a vibration part received in the receiving space and
an elastic part located between the housing and the vibration part;
a guide post located between the housing and the vibration part, and contacting the vibration part through a bearing.

2. The linear vibration motor as described in claim 1, wherein the vibration part includes a mass block located on both sides of the vibration part, and a magnetic circuit mechanism placed between the mass blocks, the guide post is installed on the mass block.

3. The linear vibration motor as described in claim 2, wherein the mass block includes a receiving hole, and one end of the guide post is placed in the receiving hole while the other end extends from the receiving hole.

4. The linear vibration motor as described in claim 3, wherein a bearing is installed on the opening of the receiving hole and sheathed on the guide post.

5. The linear vibration motor as described in claim 1, wherein a through-hole is provided in the elastic part for the guide post going through.

6. The linear vibration motor as described in claim 5, wherein the elastic part is a spiral spring, and the spiral spring is sheathed on the guide post.

7. The linear vibration motor as described in claim 5, wherein the elastic part is a flat leaf spring and includes a through-hole for the guide post going through.

8. The linear vibration motor as described in claim 3, wherein a length from the bearing to the bottom of receiving hole is larger than a maximum displacement distance of the moving vibration part.
